(19) United States
(12) Patent Application Publication
(10) Pub. No.: US 2019/0166404 A1
(43) Pub. Date: May 30, 2019

(54) CREATOR EXPERIMENTATION FRAMEWORK

(71) Applicant: Facebook, Inc., Menlo Park, CA (US)

(72) Inventors: Peng Zhao, Bellevue, WA (US); Russell Aaron Phillips, San Francisco, CA (US); Heping Gao, Issaquah, WA (US); Jonathan E. Chen, Seattle, WA (US); Abhishek Bapna, Mountain View, CA (US)

(21) Appl. No.: 15/828,250

(22) Filed: Nov. 30, 2017

(51) Int. Cl. H04N 21/472; G06Q 50/00; G06F 17/30; G06Q 30/02; H04N 21/234; H04L 29/08

(52) U.S. Cl. CPC H04N 21/472; G06Q 50/01; H04L 67/306; G06Q 30/0241; H04N 21/23424; G06F 17/30017

(57) ABSTRACT

In one embodiment, a method includes a computer server machine receiving a request from a first user to interact with a multimedia content. The computer server machine then associates the first user with a control group, wherein the control group comprises a first set of users interacting with the multimedia content. When the first user is associated with the control group, the computer server machine then applies a first content insertion model to the multimedia content and records a first set of metrics based on the interaction of the first user with the multimedia content.

### TECHNICAL FIELD

This disclosure generally relates to a framework to test user engagement with content insertion models.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g., wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

A mobile computing device—such as a smartphone, tablet computer, or laptop computer—may include functionality for determining its location, direction, or orientation, such as a GPS receiver, compass, gyroscope, or accelerometer. Such a device may also include functionality for wireless communication, such as BLUETOOTH communication, near-field communication (NFC), or infrared (IR) communication or communication with a wireless local area networks (WLANs) or cellular-telephone network. Such a device may also include one or more cameras, scanners, touchscreens, microphones, or speakers. Mobile computing devices may also execute software applications, such as games, web browsers, or social-networking applications. With social-networking applications, users may connect, communicate, and share information with other users in their social networks.

### SUMMARY OF PARTICULAR EMBODIMENTS

Particular embodiments provide techniques for testing user engagement with content insertion models. In an embodiment, a computer server machine receives a request from a first user to interact with a multimedia content. The computer server machine then associates the first user with a control group, wherein the control group comprises a first set of users interacting with the multimedia content. When the first user is associated with the control group, the computer server machine then applies a first content insertion model to the multimedia content and records a first set of metrics based on the interaction of the first user with the multimedia content.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 is an example user interface of a client device that allows a user to interact with a multimedia content.

FIG. 2 is a pictorial representation of a Content Insertion Model A and Content Insertion Model B.

FIG. 3 is an exemplary setup screenshot for the content insertion model.

FIG. 4 illustrates an example method for testing user engagement with content insertion models,

FIG. 5 illustrates an example network environment associated with a social-networking system.

FIG. 6 illustrates an example computer system.

### DESCRIPTION OF EXAMPLE EMBODIMENTS

A user may interact with a multimedia content, for example, by viewing a multimedia content on a user device. Typically, only one content insertion model (e.g., an advertising model) is applied to the multimedia content when viewed by each user. The content creator or administrator, however, cannot easily track the effect of different content insertion models on user engagement and other quantifiable metrics.

Accordingly, particular embodiments provide techniques for testing user engagement with content insertion models. In an embodiment, a computer server machine receives a request from a first user to interact with a multimedia content. The computer server machine then associates the first user with a control group, wherein the control group comprises a first set of users interacting with the multimedia content. When the first user is associated with the control group, the computer server machine then applies a first content insertion model to the multimedia content and records a first set of metrics based on the interaction of the first user with the multimedia content.

In an exemplary embodiment, a client device may communicate a request to a computer server machine to interact with a multimedia content. The request may comprise an indication of a selection of the multimedia content. In certain embodiments, a user of the device interacts with a multimedia content by selecting, clicking, or using any other type of gesture or indication that the client device and/or computer server machine recognizes as an intended interaction with a multimedia content by the user. Client device may then generate a request to the computer server machine that the user wants to interact with the multimedia content. Interacting with the multimedia content may include selecting, viewing, playing, rewinding, or any other type of actionable event that can occur with a multimedia content. Moreover, the multimedia content may include any type of content stored in memory on either the client device or the computer server machine, such as text, audio, images, animation, video, or any other type of interactive content.

In certain embodiments, one or more client devices may communicate a request to the computer server machine. For example, a second user of a second client device may attempt to interact with a multimedia content, and the second client device may subsequently communicate a request to the computer server machine. In certain embodiments, one or more users using one or more client devices may interact with the same multimedia content, and each client device may communicate a request for each individual interaction to the computer server machine.

Computer server machine typically applies a content insertion model to a multimedia content such that the viewer will view the multimedia content under the model outlined by the content insertion model. A content insertion model may be an alteration in the presentation of the original multimedia content. For example, a content insertion model may indicate an advertisement's appearance in relation to the multimedia content. The content insertion model may comprise content insertion model information. Content insertion model information may comprise any attributes or factors that relate to the insertion of content into the displayed multimedia content. For example, content insertion model information may comprise the following factors: the number of inserted content or contents displayed during the viewing of the multimedia content; category or categories of the inserted content displayed; positioning of the inserted content (e.g., fixed area of the display vs. dynamic movement of the inserted content); presentation of content at fixed time periods or dynamic time periods; size of the inserted content (e.g., ticker-sized content or entire-display-sized content); permanence of the inserted content (e.g., mandatory viewing of the inserted content or inserted content may be skippable by viewer); time length of inserted content; content format (e.g., style of content, such as audio, text, video, interactive graphic, etc.); and content medium (e.g., audio, image, video). In an exemplary embodiment wherein the content insertion model sets the appearance of one or more advertisements, the content insertion model information may comprise the advertisement format (e.g., style of advertisement or advertisements, such as audio, text, video, interactive graphic, etc.), permanence of the advertisement (skippable or mandatory advertisements), placement of the advertisement, length of the advertisement, content of the advertisement, dimensions of the advertisement, and any other factors that may alter the appearance of one or more advertisements in relation to the multimedia content.

Upon receiving the request, the computer server machine may then associate the user with either a control group or an experimental group. Typically, users associated with the control group will interact with the multimedia content using a first content insertion model, and users associated with the experimental group will interact with the multimedia content using a second content insertion model. In certain embodiments, the computer server machine may associate a first set of users interacting with the multimedia content to a control group and a second set of users interacting with the multimedia content to an experimental group.

In certain embodiments, the computer server machine determines whether a user is associated with a control group by comparing the number of first set of users in the control group and the number of the second set of users in the experimental group. For instance, an administrator may set a first percentage of users to comprise the first set of users and a second percentage of users to comprise the second set of users. By comparing the number of first set of users to the number of second set of users, the computer server machine may associate a user to the control group or experimental group to ensure that the percentage of users approaches the set percentage of users in the first set of users and/or second set of users. In certain embodiments, an administrator may limit the control and/or experimental group to a subset of users based on certain user characteristics (e.g., geography, demographic, interest, or any attributes related to the user). By doing this, the administrator may test multiple content insertion models against a set of users with one or more specified characteristics.

After receiving the request from the user, the computer server machine may apply a first content insertion model to the multimedia content when the user is associated with the control group and/or apply a second content insertion model to the multimedia content when the user is associated with the experimental group. In certain embodiments, the first content insertion model is the content insertion model that was previously applied to the multimedia content and the second content insertion model is an experimental content insertion model.

The computer server machine may then record a set of metrics based on the interaction of the user with the multimedia content. The metrics may comprise any trackable statistic and/or interaction related to the multimedia content. Examples of metrics include watch time of the multimedia content, engagement with the multimedia content, change in viewership of the multimedia content, revenue generated, reactions (e.g., comments, likes, emoticons, etc.) to the multimedia content, or any other attributable results generated by the interaction of the user with the multimedia content.

The set of metrics may be further divided based on characteristics of the users. For example, the metrics may be subdivided based on the user's geographic location, demographic, interest, or any other type of attribute assigned to that user. The computer server machine may also report one or more metrics to a third-party.

While discussed as a user interacting with the multimedia content, multiple users (e.g., a first user and a second user) can interact with the multimedia content. First user and/or second user may be associated with the control group and/or the experimental group, and the computer machine server may apply a first content insertion model to the multimedia content for the user(s) associated with the control group and a second content insertion model to the multimedia content for the user(s) associated with the experimental group. For example, a first user may be associated with the control group and, accordingly, the computer machine server may apply a first content insertion model to the multimedia content for the first user. Similarly, a second user may be associated with the experimental group and, accordingly, the computer machine server may apply a second content insertion model to the multimedia content for the second user. In addition, computer server machine may track a first set of metrics for users in the control group (e.g., first user) and a second set of metrics for the users in the experimental group (e.g., second user).

Based on the comparison of the first set of metrics to the second set of metrics, the computer server machine may determine a recommended content insertion model. For example, the computer server machine may compare a first quantifier of attributable results generated and a second quantifier of attributable results generated and then recommend either the first content insertion model or second content insertion model. In certain embodiments where the amount of quantifier of attributable results represents revenue generated, computer server machine may recommend the content assertion model that results in a higher amount of revenue generated. Computer server machine may compare a variety of metrics to determine a recommendation. These metrics may include watch time of the multimedia content, revenue generation, and engagement of the users to the multimedia content.

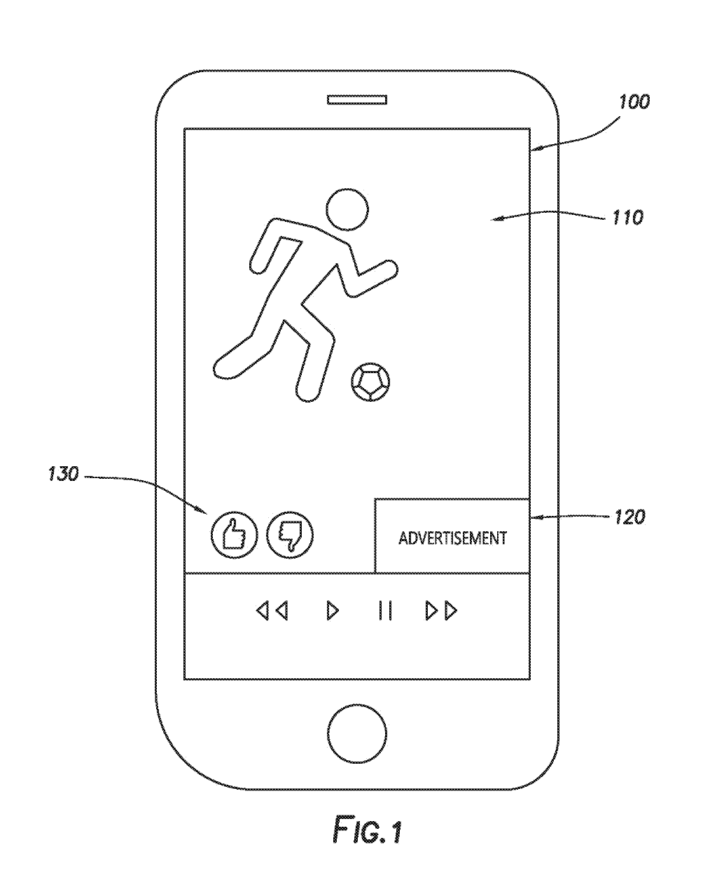

FIG. 1 is an example user interface 100 of a client device that allows a user to interact with a multimedia content. User interface 100 may comprise multimedia content 110, inserted content 120, and interactive options 130.

User interface 100 may display multimedia content 110. Multimedia content 110 may comprise text, audio, images, animation, video, or any other type of interactive content. In certain embodiments, user interface 100 may receive multimedia content 110 from a computer server machine after receiving a selection from a user to view multimedia content 110. In addition, multimedia content 110 may comprise inserted content 120. Inserted content 120 may be an alteration to the presentation of multimedia content 110 as set by the content insertion model. In certain embodiments, inserted content 120 may be a mandatory or skippable advertisement. Inserted content 120 may overlay multimedia content 110, may exist in a separate frame apart from multimedia content 110, or may be in any other form such that inserted content 120 is presented to the viewing user.

Interactive options 130 may provide options for the user to interact with the presented multimedia content 110. For example, a user may leave a comment, like, emoticon, or any other type of user action that is associated with multimedia content 110. Moreover, interactive options 130 may also include pausing, skipping, fast forwarding, rewinding or and other actions from the user with regards to the multimedia content. Computer server machine may log the user's interaction using the interactive options 130 in order to provide statistics on the user's interactions under each content insertion model. For example, computer server machine may report metrics using a state-based logging technique. In this example, a computer server machine may receive a first interaction and may identify a current interactive state of a viewing session by the user using a state machine. The computer server machine may also receive a second interaction. Using the state machine, the computer server machine may determine a subsequent interactive state of the viewing session. The computer server machine may then calculate metrics for the viewing session based on its current state and subsequent state.

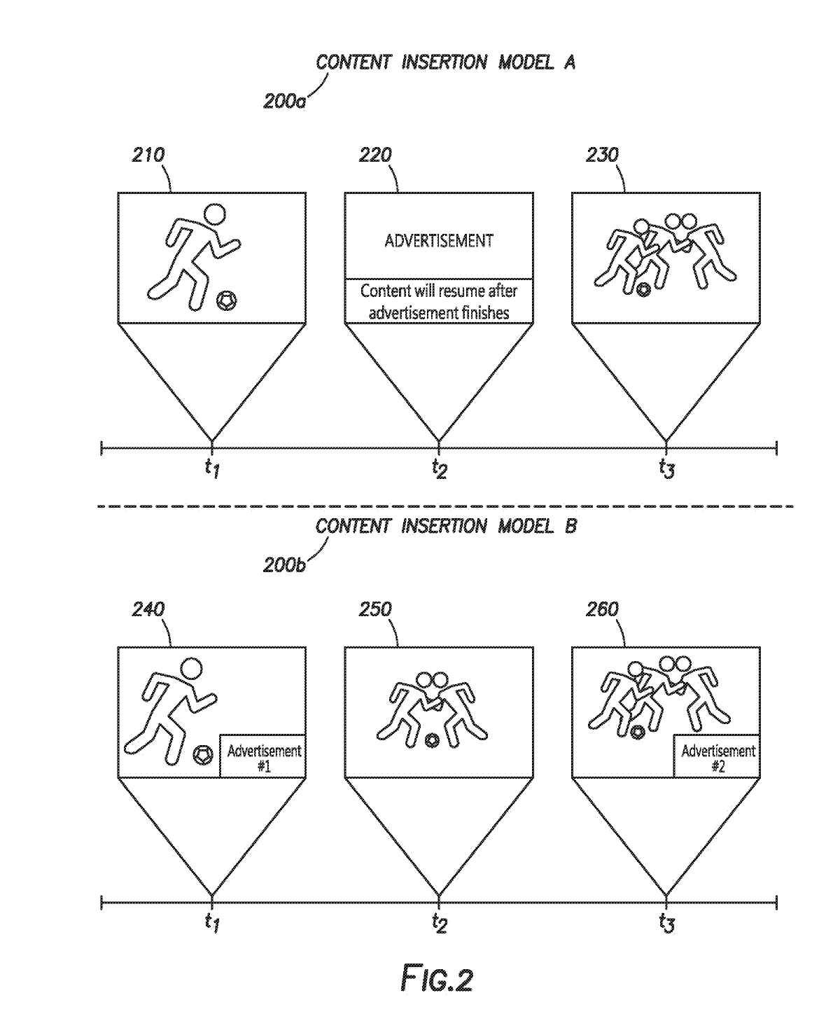

FIG. 2 is a pictorial representation of Content Insertion Model A 200a and Content Insertion Model B 200b. Content Insertion Model A 200a comprises three separate frames: first frame 210 at time t1, second frame 220 at time t2, and third frame 230 at time t3. Similarly, Content Insertion Model B 200b comprises three separate frames: first frame 240 at time t1, second frame 250 at time t2, and third frame 260 at time t3.

Content Insertion Model A 200a comprises a different content insertion model than Content Insertion Model B 200b. In Content Insertion Model A 200a, frames 210 and 230 display the multimedia content without any inserted content. However, frame 220 contains mandatory inserted content 225 (e.g., advertisement) that consumes the entire frame. Computer server machine may log a user's interaction when displaying the multimedia content under Content Insertion Model A in order to provide statistics on the user's interactions under Content Insertion Model A.

In Content Insertion Model B 200b and unlike frames 210 and 230 in Content Insertion Model A 200a, frames 240 and 260 display inserted content 245 and 265, respectively, at the lower right-hand side of the frame. Moreover, unlike frame 220 in Content Insertion Model A, frame 250 at time t2 in Content Insertion Model B 200b does not contain any inserted content. A user, under Content Insertion Model B 200b, may interact with the multimedia content differently than other users under Content Insertion Model A 200a. For example, on average, users under Content Insertion Model B 200b may have liked the multimedia content more times than under Content Insertion Model A 200a. By logging the user's interactions under each content insertion model, an administrator or content creator can view these types of statistics in order to make a decision of which content insertion model is more beneficial.

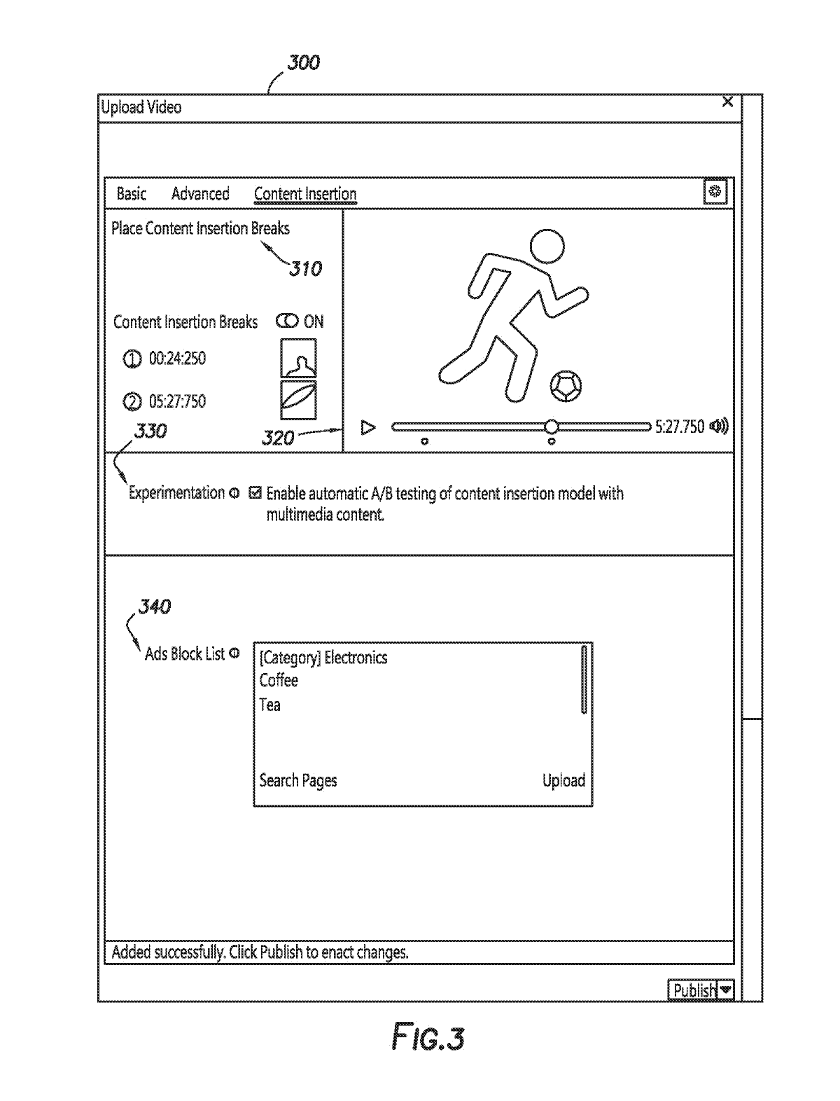

FIG. 3 is an exemplary setup screenshot 300 for the content insertion model. Setup screenshot 300 comprises content insertion section 310, preview pane 320, experimentation section 330, and content black list 340.

Content insertion section 310 comprises options for when a viewing user sees inserted content. As illustrated, a user may view advertisements at time 00:24.250 and 05:27.750 when viewing the multimedia content. The administrator accessing content insertion section 310 may modify the content insertion model to modify the number of content displayed (which may include no content displayed); category or categories of content played; positioning of content (e.g., fixed vs. dynamic); presentation of content at fixed time periods or dynamically presented; presentation of content (e.g., ticker-sized content or entire-display-sized content); mandatory or skippable content; length of content; content format; and content medium. An administrator may view preview pane 320 to review the multimedia content under the customized content insertion model.

Experimentation section 330 allows the administrator to perform testing of the various content insertion models when viewers view the multimedia content. In certain embodiments, an administrator may indicate the number of users in a control group and the number of users in an experimental group. While depicted as A/B testing, any number of content insertion models may be tested. In certain embodiments, the administrator may also set a percentage of users under each group. For example, the administrator may require 40% of users to be part of the control group and 60% of subscribers to be part of the experimental group. In addition, the administrator may also limit the A/B testing to users in a certain geographic location, demographic, interest, or any other type of attribute assigned to that user.

Content block list 340 allows the administrator to indicate the types of inserted content that are prohibited from being used as an inserted content for the multimedia content. For example, in the illustrated example, coffee and teas are categories of content that the computer server machine will not use as an inserted content for the content insertion model.

In certain embodiments, content black list 340 may also be part of the testing. For example, users under the experimental group may see content under the categories under content black list 340, whereas users under the control group may be restricted from seeing content under the categories in content black list 340.

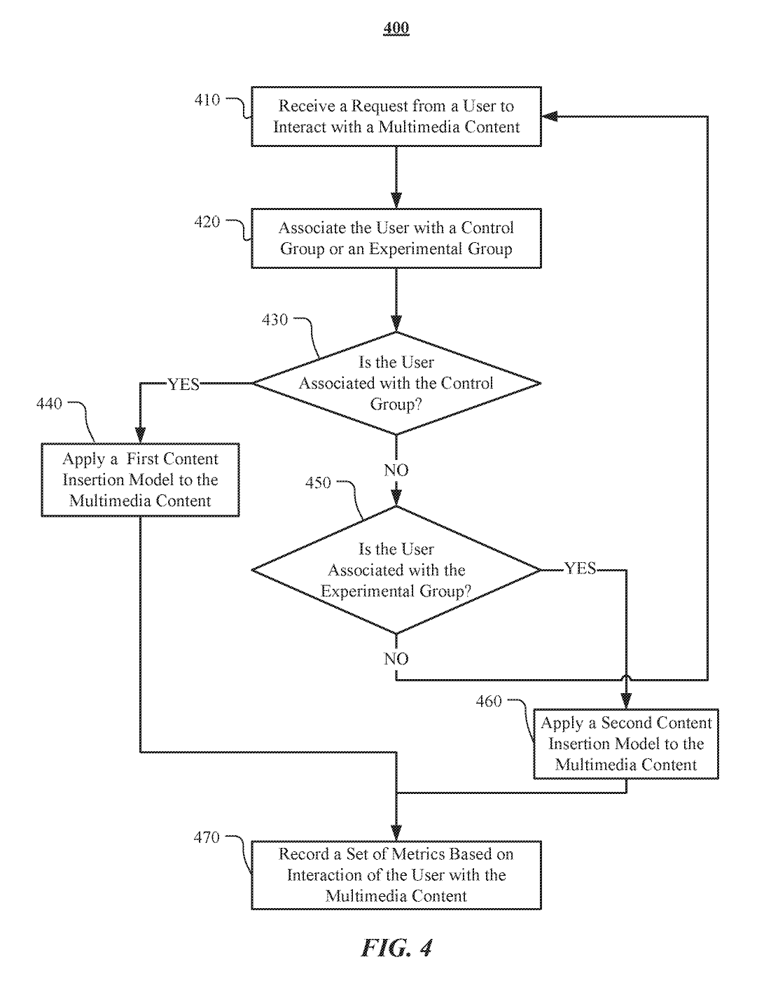

FIG. 4 illustrates an example method for testing user engagement with content insertion models. At step 410, a computer server machine receives a request from a user to interact with a multimedia content. The request may comprise an indication of a selection of a multimedia content. Interacting with the multimedia content may include selecting, viewing, playing, rewinding, or any other type of actionable event that can occur with a multimedia content. In certain embodiments, multiple client devices may communicate a request to the computer server machine.

At step 420, the computer server machine associates the user with a control group or an experimental group. In certain embodiments, the computer server machine determines whether a first user is associated with a control group by comparing the number of first set of users in the control group and the number of the second set of users in the experimental group. Moreover, the computer server machine may limit the control and/or experimental group to a subset of users based on certain user characteristics (e.g., geography, demographic, interest, or any attributes related to the user).

At step 430, the computer server machine may determine whether the user is associated with the control group. If the user is associated with the control group, the method proceeds to step 440 where the computer server machine applies a first content insertion model to the multimedia content. Otherwise, the method proceeds to step 450.

At step 450, the computer server machine may determine whether the user is associated with the experimental group. If the user is associated with the control group, the method proceeds to step 460 where the computer server machine applies a second content insertion model to the multimedia content. Otherwise, the method proceeds to step 410.

At step 470, the computer server machine may then record a set of metrics based on the interaction of the first user with the multimedia content using the respective content insertion model. The metrics may comprise any trackable statistic and/or interaction related to the multimedia content.

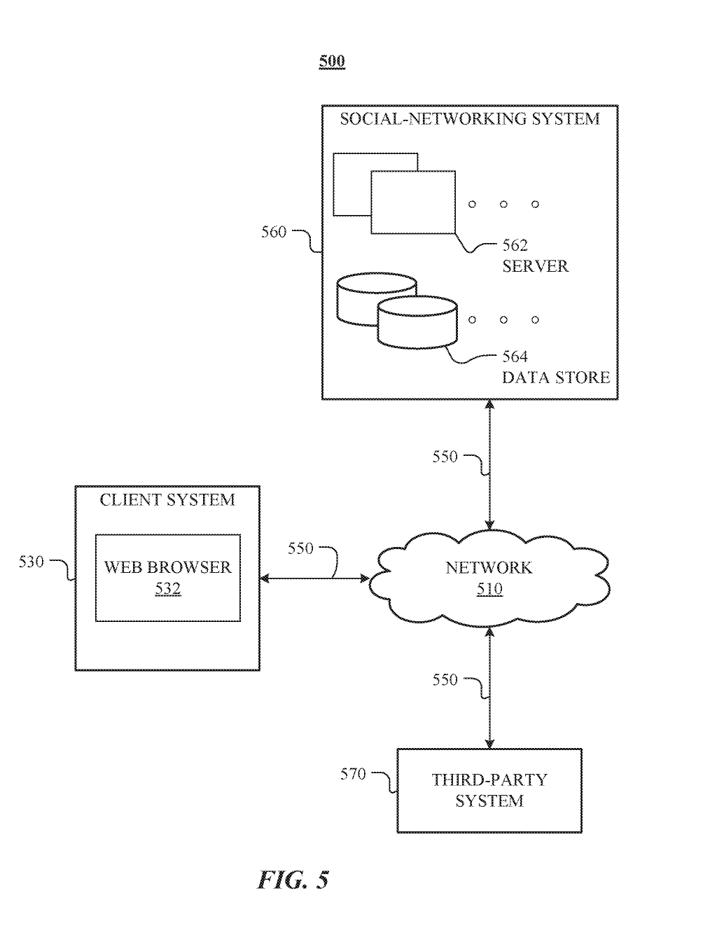

FIG. 5 illustrates an example network environment 500 associated with a social-networking system. Network environment 500 includes a client system 530, a social-networking system 560, and a third-party system 570 connected to each other by a network 510. Although FIG. 5 illustrates a particular arrangement of client system 530, social-networking system 560, third-party system 570, and network 510, this disclosure contemplates any suitable arrangement of client system 530, social-networking system 560, third-party system 570, and network 510. As an example and not by way of limitation, two or more of client system 530, social-networking system 560, and third-party system 570 may be connected to each other directly, bypassing network 510. As another example, two or more of client system 530, social-networking system 560, and third-party system 570 may be physically or logically co-located with each other in whole or in part. Moreover, although FIG. 5 illustrates a particular number of client systems 530, social-networking systems 560, third-party systems 570, and networks 510, this disclosure contemplates any suitable number of client systems 530, social-networking systems 560, third-party systems 570, and networks 510. As an example and not by way of limitation, network environment 500 may include multiple client system 530, social-networking systems 560, third-party systems 570, and networks 510.

This disclosure contemplates any suitable network 510. As an example and not by way of limitation, one or more portions of network 510 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 510 may include one or more networks 510.

Links 550 may connect client system 530, social-networking system 560, and third-party system 570 to communication network 510 or to each other. This disclosure contemplates any suitable links 550. In particular embodiments, one or more links 550 include one or more wireline (such as for example Digital Subscriber Line (DSL) or Data Over Cable Service Interface Specification (DOC SIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 550 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 550, or a combination of two or more such links 550. Links 550 need not necessarily be the same throughout network environment 500. One or more first links 550 may differ in one or more respects from one or more second links 550.

In particular embodiments, client system 530 may be an electronic device including hardware, software, or embedded logic components or a combination of two or more such components and capable of carrying out the appropriate functionalities implemented or supported by client system 530. In certain embodiments, client system 530 may comprise a client device. As an example and not by way of limitation, a client system 530 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 530. A client system 530 may enable a network user at client system 530 to access network 510. A client system 530 may enable its user to communicate with other users at other client systems 530.

In particular embodiments, client system 530 may include a web browser 532, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 530 may enter a Uniform Resource Locator (URL) or other address directing the web browser 532 to a particular server (such as server 562, or a server associated with a third-party system 570), and the web browser 532 may generate a Hyper Text Transfer Protocol (HTTP) request and communicate the HTTP request to server. The server may accept the HTTP request and communicate to client system 530 one or more Hyper Text Markup Language (HTML) files responsive to the HTTP request. Client system 530 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 560 may be a network-addressable computing system that can host an online social network. Social-networking system 560 may generate, store, receive, and send social-networking data, such as, for example, user-profile data, concept-profile data, social-graph information, or other suitable data related to the online social network. Social-networking system 560 may be accessed by the other components of network environment 500 either directly or via network 510. As an example and not by way of limitation, client system 530 may access social-networking system 560 using a web browser 532, or a native application associated with social-networking system 560 (e.g., a mobile social-networking application, a messaging application, another suitable application, or any combination thereof) either directly or via network 510. In particular embodiments, social-networking system 560 may include one or more servers 562. In certain embodiments, servers 562 may comprise a computer-server machine. Each server 562 may be a unitary server or a distributed server spanning multiple computers or multiple datacenters. Servers 562 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 562 may include hardware, software, or embedded logic components or a combination of two or more such components for carrying out the appropriate functionalities implemented or supported by server 562. In particular embodiments, social-networking system 560 may include one or more data stores 564. Data stores 564 may be used to store various types of information. In particular embodiments, the information stored in data stores 564 may be organized according to specific data structures. In particular embodiments, each data store 564 may be a relational, columnar, correlation, or other suitable database. Although this disclosure describes or illustrates particular types of databases, this disclosure contemplates any suitable types of databases. Particular embodiments may provide interfaces that enable a client system 530, a social-networking system 560, or a third-party system 570 to manage, retrieve, modify, add, or delete, the information stored in data store 564.

In particular embodiments, social-networking system 560 may store one or more social graphs in one or more data stores 564. In particular embodiments, a social graph may include multiple nodes—which may include multiple user nodes (each corresponding to a particular user) or multiple concept nodes (each corresponding to a particular concept)—and multiple edges connecting the nodes. Social-networking system 560 may provide users of the online social network the ability to communicate and interact with other users. In particular embodiments, users may join the online social network via social-networking system 560 and then add connections (e.g., relationships) to a number of other users of social-networking system 560 to whom they want to be connected. Herein, the term “friend” may refer to any other user of social-networking system 560 with whom a user has formed a connection, association, or relationship via social-networking system 560.

In particular embodiments, social-networking system 560 may provide users with the ability to take actions on various types of items or objects, supported by social-networking system 560. As an example and not by way of limitation, the items and objects may include groups or social networks to which users of social-networking system 560 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 560 or by an external system of third-party system 570, which is separate from social-networking system 560 and coupled to social-networking system 560 via a network 510.

In particular embodiments, social-networking system 560 may be capable of linking a variety of entities. As an example and not by way of limitation, social-networking system 560 may enable users to interact with each other as well as receive content from third-party systems 570 or other entities, or to allow users to interact with these entities through an application programming interfaces (API) or other communication channels.

In particular embodiments, a third-party system 570 may include one or more types of servers, one or more data stores, one or more interfaces, including but not limited to APIs, one or more web services, one or more content sources, one or more networks, or any other suitable components, e.g., that servers may communicate with. A third-party system 570 may be operated by a different entity from an entity operating social-networking system 560. In particular embodiments, however, social-networking system 560 and third-party systems 570 may operate in conjunction with each other to provide social-networking services to users of social-networking system 560 or third-party systems 570. In this sense, social-networking system 560 may provide a platform, or backbone, which other systems, such as third-party systems 570, may use to provide social-networking services and functionality to users across the Internet.

In particular embodiments, a third-party system 570 may include a third-party content object provider. A third-party content object provider may include one or more sources of content objects, which may be communicated to a client system 530. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 560 also includes user-generated content objects, which may enhance a user's interactions with social-networking system 560. User-generated content may include anything a user can add, upload, send, or “post” to social-networking system 560. As an example and not by way of limitation, a user communicates posts to social-networking system 560 from a client system 530. Posts may include data such as status updates or other textual data, location information, photos, videos, links, music or other similar data or media. Content may also be added to social-networking system 560 by a third-party through a “communication channel,” such as a newsfeed or stream.

In particular embodiments, social-networking system 560 may include a variety of servers, sub-systems, programs, modules, logs, and data stores. In particular embodiments, social-networking system 560 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 560 may also include suitable components such as network interfaces, security mechanisms, load balancers, failover servers, management-and-network-operations consoles, other suitable components, or any suitable combination thereof. In particular embodiments, social-networking system 560 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 560 to one or more client systems 530 or one or more third-party system 570 via network 510. The web server may include a mail server or other messaging functionality for receiving and routing messages between social-networking system 560 and one or more client systems 530. An API-request server may allow a third-party system 570 to access information from social-networking system 560 by calling one or more APIs. An action logger may be used to receive communications from a web server about a user's actions on or off social-networking system 560. In conjunction with the action log, a third-party-content-object log may be maintained of user exposures to third-party-content objects. A notification controller may provide information regarding content objects to a client system 530. Information may be pushed to a client system 530 as notifications, or information may be pulled from client system 530 responsive to a request received from client system 530. Authorization servers may be used to enforce one or more privacy settings of the users of social-networking system 560. A privacy setting of a user determines how particular information associated with a user can be shared. The authorization server may allow users to opt in to or opt out of having their actions logged by social-networking system 560 or shared with other systems (e.g., third-party system 570), such as, for example, by setting appropriate privacy settings. Third-party-content-object stores may be used to store content objects received from third parties, such as a third-party system 570. Location stores may be used for storing location information received from client systems 530 associated with users. Advertisement-pricing modules may combine social information, the current time, location information, or other suitable information to provide relevant advertisements, in the form of notifications, to a user.

In particular embodiments, an advertisement may be text (which may be HTML-linked), one or more images (which may be HTML-linked), one or more videos, audio, other suitable digital object files, a suitable combination of these, or any other suitable advertisement in any suitable digital format presented on one or more web pages, in one or more e-mails, or in connection with search results requested by a user. In addition or as an alternative, an advertisement may be one or more sponsored stories (e.g., a news-feed or ticker item on social-networking system 560). A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes, for example, by having the social action presented within a pre-determined area of a profile page of a user or other page, presented with additional information associated with the advertiser, bumped up or otherwise highlighted within news feeds or tickers of other users, or otherwise promoted. The advertiser may pay to have the social action promoted. The social action may be promoted within or on social-networking system 560. In addition or as an alternative, the social action may be promoted outside or off of social-networking system 560, where appropriate. In particular embodiments, a page may be an on-line presence (such as a webpage or website within or outside of social-networking system 560) of a business, organization, or brand facilitating its sharing of stories and connecting with people. A page may be customized, for example, by adding applications, posting stories, or hosting events.

A sponsored story may be generated from stories in users' news feeds and promoted to specific areas within displays of users' web browsers when viewing a web page associated with social-networking system 560. Sponsored stories are more likely to be viewed by users, at least in part because sponsored stories generally involve interactions or suggestions by the users' friends, fan pages, or other connections. In connection with sponsored stories, particular embodiments may utilize one or more systems, components, elements, functions, methods, operations, or steps disclosed in U.S. patent application Ser. No. 13/327,557, entitled “Sponsored Stories Unit Creation from Organic Activity Stream” and filed 15 Dec. 2011, U.S. Patent Application Publication No. 2012/0203831, entitled “Sponsored Stories Unit Creation from Organic Activity Stream” and filed 3 Feb. 2012 as U.S. patent application Ser. No. 13/020,745, or U.S. Patent Application Publication No. 2012/0233009, entitled “Endorsement Subscriptions for Sponsored Stories” and filed 9 Mar. 2011 as U.S. patent application Ser. No. 13/044,506, which are all incorporated herein by reference as an example and not by way of limitation. In particular embodiments, sponsored stories may utilize computer-vision algorithms to detect products in uploaded images or photos lacking an explicit connection to an advertiser as disclosed in U.S. patent application Ser. No. 13/212,356, entitled “Computer-Vision Content Detection for Sponsored Stories” and filed 18 Aug. 2011, which is incorporated herein by reference as an example and not by way of limitation.

As described above, an advertisement may be text (which may be HTML-linked), one or more images (which may be HTML-linked), one or more videos, audio, one or more ADOBE FLASH files, a suitable combination of these, or any other suitable advertisement in any suitable digital format. In particular embodiments, an advertisement may be requested for display within third-party webpages, social-networking-system webpages, or other pages. An advertisement may be displayed in a dedicated portion of a page, such as in a banner area at the top of the page, in a column at the side of the page, in a GUI of the page, in a pop-up window, over the top of content of the page, or elsewhere with respect to the page. In addition or as an alternative, an advertisement may be displayed within an application or within a game. An advertisement may be displayed within dedicated pages, requiring the user to interact with or watch the advertisement before the user may access a page, utilize an application, or play a game. The user may, for example view the advertisement through a web browser.

A user may interact with an advertisement in any suitable manner. The user may click or otherwise select the advertisement, and the advertisement may direct the user (or a browser or other application being used by the user) to a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). In particular embodiments, an advertisement may include one or more games, which a user or other application may play in connection with the advertisement. An advertisement may include functionality for responding to a poll or question in the advertisement.

An advertisement may include social-networking-system functionality that a user may interact with. For example, an advertisement may enable a user to “like” or otherwise endorse the advertisement by selecting an icon or link associated with endorsement. Similarly, a user may share the advertisement with another user (e.g., through social-networking system 560) or RSVP (e.g., through social-networking system 560) to an event associated with the advertisement. In addition or as an alternative, an advertisement may include social-networking-system content directed to the user. For example, an advertisement may display information about a friend of the user within social-networking system 560 who has taken an action associated with the subject matter of the advertisement.

Social-networking-system functionality or content may be associated with an advertisement in any suitable manner. For example, an advertising system (which may include hardware, software, or both for receiving bids for advertisements and selecting advertisements in response) may retrieve social-networking functionality or content from social-networking system 560 and incorporate the retrieved social-networking functionality or content into the advertisement before serving the advertisement to a user. Examples of selecting and providing social-networking-system functionality or content with an advertisement are disclosed in U.S. Patent Application Publication No. 2012/0084160, entitled “Providing Social Endorsements with Online Advertising” and filed 5 Oct. 2010 as U.S. patent application Ser. No. 12/898,662, and in U.S. Patent Application Publication No. 2012/0232998, entitled “Selecting Social Endorsement Information for an Advertisement for Display to a Viewing User” and filed 8 Mar. 2011 as U.S. patent application Ser. No. 13/043,424, which are both incorporated herein by reference as examples only and not by way of limitation. Interacting with an advertisement that is associated with social-networking-system functionality or content may cause information about the interaction to be displayed in a profile page of the user in social-networking-system 560.

Particular embodiments may facilitate the delivery of advertisements to users that are more likely to find the advertisements more relevant or useful. For example, an advertiser may realize higher conversion rates (and therefore higher return on investment (ROI) from advertising) by identifying and targeting users that are more likely to find its advertisements more relevant or useful. The advertiser may use user-profile information in social-networking system 560 to identify those users. In addition or as an alternative, social-networking system 560 may use user-profile information in social-networking system 560 to identify those users for the advertiser. As examples and not by way of limitation, particular embodiments may target users with the following: invitations or suggestions of events; suggestions regarding coupons, deals, or wish-list items; suggestions regarding friends' life events; suggestions regarding groups; advertisements; or social advertisements. Such targeting may occur, where appropriate, on or within social-networking system 560, off or outside of social-networking system 560, or on mobile computing devices of users. When on or within social-networking system 560, such targeting may be directed to users' news feeds, search results, e-mail or other in-boxes, or notifications channels or may appear in particular area of web pages of social-networking system 560, such as a right-hand side of a web page in a concierge or grouper area (which may group along a right-hand rail advertisements associated with the same concept, node, or object) or a network-ego area (which may be based on what a user is viewing on the web page and a current news feed of the user). When off or outside of social-networking system 560, such targeting may be provided through a third-party website, e.g., involving an ad exchange or a social plug-in. When on a mobile computing device of a user, such targeting may be provided through push notifications to the mobile computing device.

Targeting criteria used to identify and target users may include explicit, stated user interests on social-networking system 560 or explicit connections of a user to a node, object, entity, brand, or page on social-networking system 560. In addition or as an alternative, such targeting criteria may include implicit or inferred user interests or connections (which may include analyzing a user's history, demographic, social or other activities, friends' social or other activities, subscriptions, or any of the preceding of other users similar to the user (based, e.g., on shared interests, connections, or events)). Particular embodiments may utilize platform targeting, which may involve platform and “like” impression data; contextual signals (e.g., “Who is viewing now or has viewed recently the page for COCA-COLA?”); light-weight connections (e.g., “check-ins”); connection lookalikes; fans; extracted keywords; EMU advertising; inferential advertising; coefficients, affinities, or other social-graph information; friends-of-friends connections; pinning or boosting; deals; polls; household income, social clusters or groups; products detected in images or other media; social- or open-graph edge types; geo-prediction; views of profile or pages; status updates or other user posts (analysis of which may involve natural-language processing or keyword extraction); events information; or collaborative filtering. Identifying and targeting users may also include privacy settings (such as user opt-outs), data hashing, or data anonymization, as appropriate.

To target users with advertisements, particular embodiments may utilize one or more systems, components, elements, functions, methods, operations, or steps disclosed in the following, which are all incorporated herein by reference as examples and not by way of limitation: U.S. Patent Application Publication No. 2009/0119167, entitled “Social Advertisements and Other Informational Messages on a Social Networking Website and Advertising Model for Same” and filed 18 Aug. 2008 as U.S. patent application Ser. No. 12/193,702; U.S. Patent Application Publication No. 2009/0070219, entitled “Targeting Advertisements in a Social Network” and filed 20 Aug. 2008 as U.S. patent application Ser. No. 12/195,321; U.S. Patent Application Publication No. 2012/0158501, entitled “Targeting Social Advertising to Friends of Users Who Have Interacted With an Object Associated with the Advertising” and filed 15 Dec. 2010 as U.S. patent application Ser. No. 12/968,786; or U.S. Patent Application Publication No. 2012/0166532, entitled “Contextually Relevant Affinity Prediction in a Social-Networking System” and filed 23 Dec. 2010 as U.S. patent application Ser. No. 12/978,265.

An advertisement may be presented or otherwise delivered using plug-ins for web browsers or other applications, iframe elements, news feeds, tickers, notifications (which may include, for example, e-mail, Short Message Service (SMS) messages, or notifications), or other means. An advertisement may be presented or otherwise delivered to a user on a mobile or other computing device of the user. In connection with delivering advertisements, particular embodiments may utilize one or more systems, components, elements, functions, methods, operations, or steps disclosed in the following, which are all incorporated herein by reference as examples and not by way of limitation: U.S. Patent Application Publication No. 2012/0159635, entitled “Comment Plug-In for Third-Party System” and filed 15 Dec. 2010 as U.S. patent application Ser. No. 12/969,368; U.S. Patent Application Publication No. 2012/0158753, entitled “Comment Ordering System” and filed 15 Dec. 2010 as U.S. patent application Ser. No. 12/969,408; U.S. Pat. No. 7,669,123, entitled “Dynamically Providing a News Feed About a User of a Social Network” and filed 11 Aug. 2006 as U.S. patent application Ser. No. 11/503,242; U.S. Pat. No. 8,402,094, entitled “Providing a Newsfeed Based on User Affinity for Entities and Monitored Actions in a Social Network Environment” and filed 11 Aug. 2006 as U.S. patent application Ser. No. 11/503,093; U.S. Patent Application Publication No. 2012/0072428, entitled “Action Clustering for News Feeds” and filed 16 Sep. 2010 as U.S. patent application Ser. No. 12/884,010; U.S. Patent Application Publication No. 2011/0004692, entitled “Gathering Information about Connections in a Social Networking Service” and filed 1 Jul. 2009 as U.S. patent application Ser. No. 12/496,606; U.S. Patent Application Publication No. 2008/0065701, entitled “Method and System for Tracking Changes to User Content in an Online Social Network” and filed 12 Sep. 2006 as U.S. patent application Ser. No. 11/531,154; U.S. Patent Application Publication No. 2008/0065604, entitled “Feeding Updates to Landing Pages of Users of an Online Social Network from External Sources” and filed 17 Jan. 2007 as U.S. patent application Ser. No. 11/624,088; U.S. Pat. No. 8,244,848, entitled “Integrated Social-Network Environment” and filed 19 Apr. 2010 as U.S. patent application Ser. No. 12/763,171; U.S. Patent Application Publication No. 2011/0083101, entitled “Sharing of Location-Based Content Item in Social-Networking Service” and filed 6 Oct. 2009 as U.S. patent application Ser. No. 12/574,614; U.S. Pat. No. 8,150,844, entitled “Location Ranking Using Social-Graph Information” and filed 18 Aug. 2010 as U.S. patent application Ser. No. 12/858,718; U.S. patent application Ser. No. 13/051,286, entitled “Sending Notifications to Users Based on Users' Notification Tolerance Levels” and filed 18 Mar. 2011; U.S. patent application Ser. No. 13/096,184, entitled “Managing Notifications Pushed to User Devices” and filed 28 Apr. 2011; U.S. patent application Ser. No. 13/276,248, entitled “Platform-Specific Notification Delivery Channel” and filed 18 Oct. 2011; or U.S. Patent Application Publication No. 2012/0197709, entitled “Mobile Advertisement with Social Component for Geo-Social Networking System” and filed 1 Feb. 2011 as U.S. patent application Ser. No. 13/019,061. Although this disclosure describes or illustrates particular advertisements being delivered in particular ways and in connection with particular content, this disclosure contemplates any suitable advertisements delivered in any suitable ways and in connection with any suitable content.

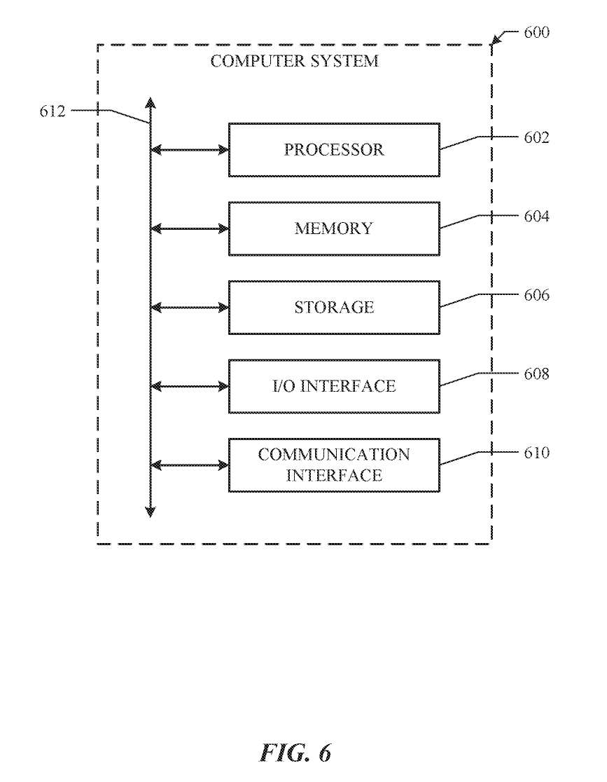

FIG. 6 illustrates an example computer system 600. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600. Herein, reference to a computer system may encompass a computing device, and vice versa, where appropriate. Moreover, reference to a computer system may encompass one or more computer systems, where appropriate.

This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example and not by way of limitation, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method, comprising:
by a computer server machine, receiving a request from a first user to interact with a multimedia content;
by the computer server machine, associating the first user with a control group, wherein the control group comprises a first set of users interacting with the multimedia content;
by the computer server machine, applying a first content insertion model to the multimedia content when the first user is associated with the control group;
by the computer server machine, recording a first set of metrics, wherein the first set of metrics comprises a first quantifier of attributable results generated by the interaction of the first user with the multimedia content;
by the computer server machine, obtaining a second set of metrics comprising a second quantifier of attributable results generated by interaction of a second user with the multimedia content, wherein the second user is associated with an experimental group corresponding to a second content insertion model; and
by the computer server machine, determining a recommended content insertion model based on a comparison of the first quantifier of attributable results and the second quantifier of attributable results.

2. The method of claim 1, further comprising:
by the computer server machine, receiving a request from a second user to interact with the multimedia content;
by the computer server machine, associating the second user with an experimental group, wherein the experimental group comprises a second set of users interacting with the multimedia content;
by the computer server machine, applying a second content insertion model to the multimedia content when the second user is associated with the experimental group; and
by the computer server machine, logging a second set of metrics based on the interaction of second user with the multimedia content.

3. The method of claim 2, further comprising, by the computer server machine, determining whether the first user is associated with the control group by comparing the number of first set of users in the control group and the number of second set of users in the experimental group.

4. (canceled)

5. The method of claim 1, wherein the first content insertion model comprises content insertion model information, wherein the content insertion model information comprises at least one of the following:
number of content insertions;
category of content insertions;
positioning of content insertions;
length of content insertions;
inserted-content format; or
permanence of inserted content.

6. The method of claim 1, wherein the first quantifier of attributable results comprises at least one of the following:
quantified results generated from the interaction of the first user with the multimedia content;
length of interaction of the first user with the multimedia content;
engagement of the first user with the multimedia content; or
reaction of the first user to the multimedia content.

7. The method of claim 1, wherein the first content insertion model is a content insertion model previously applied to the multimedia content.

8. One or more computer-readable non-transitory storage media embodying software that is operable when executed to:
receive a request from a first user to interact with a multimedia content;
associate the first user with a control group, wherein the control group comprises a first set of users interacting with the multimedia content;
apply a first content insertion model to the multimedia content when the first user is associated with the control group;
record a first set of metrics, wherein the first set of metrics comprises a first quantifier of attributable results generated by the interaction of the first user with the multimedia content;
obtain a second set of metrics comprising a second quantifier of attributable results generated by interaction of a second user with the multimedia content, wherein the second user is associated with an experimental group corresponding to a second content insertion model; and
determine a recommended content insertion model based on a comparison of the first quantifier of attributable results and the second quantifier of attributable results.

9. The media of claim 8, wherein the software is further operable when executed to:
receive a request from a second user to interact with the multimedia content;
associate the second user with an experimental group, wherein the experimental group comprises a second set of users interacting with the multimedia content;
apply a second content insertion model to the multimedia content when the second user is associated with the experimental group; and
log a second set of metrics based on the interaction of second user with the multimedia content.

10. The media of claim 9, wherein the software is further operable when executed to determine whether the first user is associated with the control group by comparing the number of first set of users in the control group and the number of second set of users in the experimental group.

11. (canceled)

12. The media of claim 8, wherein the first content insertion model comprises content insertion model information, wherein the content insertion model information comprises at least one of the following:
number of content insertions;
category of content insertions;
positioning of content insertions;
length of content insertions;
inserted-content format; or
permanence of inserted content.

13. The media of claim 8, wherein the first quantifier of attributable results comprises at least one of the following:
quantified results generated from the interaction of the first user with the multimedia content;
length of interaction of the first user with the multimedia content;
engagement of the first user with the multimedia content; or
reaction of the first user to the multimedia content.

14. The media of claim 8, wherein the first content insertion model is a content insertion model previously applied to the multimedia content.

15. A system comprising:
one or more processors; and
one or more computer-readable non-transitory storage media coupled to one or more of the processors and comprising instructions operable when executed by one or more of the processors to cause the system to:
receive a request from a first user to interact with a multimedia content;
associate the first user with a control group, wherein the control group comprises a first set of users interacting with the multimedia content;
apply a first content insertion model to the multimedia content when the first user is associated with the control group;
record a first set of metrics, wherein the first set of metrics comprises a first quantifier of attributable results generated by the interaction of the first user with the multimedia content;
obtain a second set of metrics comprising a second quantifier of attributable results generated by interaction of a second user with the multimedia content, wherein the second user is associated with an experimental group corresponding to a second content insertion model; and
determine a recommended content insertion model based on a comparison of the first quantifier of attributable results and the second quantifier of attributable results.

16. The system of claim 15, wherein the processors are further operable when executing the instructions to:
receive a request from a second user to interact with the multimedia content;
associate the second user with an experimental group, wherein the experimental group comprises a second set of users interacting with the multimedia content;
apply a second content insertion model to the multimedia content when the second user is associated with the experimental group; and
log a second set of metrics based on the interaction of second user with the multimedia content.

17. The system of claim 16, wherein the processors are further operable when executing the instructions to determine whether the first user is associated with the control group by comparing the number of first set of users in the control group and the number of second set of users in the experimental group.

18. (canceled)

19. The system of claim 15, wherein the first content insertion model comprises content insertion model information, wherein the content insertion model information comprises at least one of the following:
number of content insertions;
category of content insertions;
positioning of content insertions;
length of content insertions;
inserted-content format; or
permanence of inserted content.

20. The system of claim 15, wherein the first quantifier of attributable results comprises at least one of the following:
quantified results generated from the interaction of the first user with the multimedia content;
length of interaction of the first user with the multimedia content;
engagement of the first user with the multimedia content; or
reaction of the first user to the multimedia content.

21. The system of claim 15, wherein the first content insertion model is a content insertion model previously applied to the multimedia content.
